(19) United States
(12) Patent Application Publication
(10) Pub. No.: US 2005/0147093 A1
(43) Pub. Date: Jul. 7, 2005

(54) Computer system for configuring firmware for an automation device

(75) Inventors: Eduardo Bertrand, Erlangen (DE); Georg Steinlein, Neudrossenfeld (DE); Till-Christian Siering, Forchheim (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 11/040,186

(22) Filed: Jan. 21, 2005

Related U.S. Application Data
(63) Continuation of application No. PCT/DE03/02301, filed on Jul. 9, 2003.

(30) Foreign Application Priority Data
Jul. 22, 2002 (DE) 102 33 211.8

(51) Int. Cl. H04L 12/56

(52) U.S. Cl. 370/389

(57) ABSTRACT

A computer system for configuring firmware for an automation device is disclosed, wherein the firmware includes packets. The computer system includes a database with an image of a data model of the firmware of the automation device, an input device for instantiating entities of the data model; and a processor that generates the packets for implementing the instantiated entities. The database stores a first packet for an alarm, a second packet for instantiating a number of axes, and a third packet for a controller. A first attribute for controller-type-independent packets is associated with the first packet, a second attribute for controller-type-independent axial packets is associated with the second packet, and a third attribute for controller-type-dependent axial packets is associated with the third packet.

### CROSS-REFERENCES TO RELATED APPLICATIONS

This application is a continuation of prior filed copending PCT International application no. PCT/DE2003/002301, filed Jul. 9, 2003, which designated the United States and on which priority is claimed under 35 U.S.C. §120 and which claims the priority of German Patent Application, Serial No. 102 33 211.8, filed Jul. 22, 2002, pursuant to 35 U.S.C. 119(a)-(d).

### BACKGROUND OF THE INVENTION

The present invention relates to a computer system for configuring firmware for an automation device.

Nothing in the following discussion of the state of the art is to be construed as an admission of prior art.

So-called “open” drive controllers and methods for generating software for these open drive controllers are known in the art. The term drive controller typically refers to, for example, converters and associated software for operating electric and/or hydraulic actuators, such as motors. Also known in the art are so-called “intelligent” drives that can be automated in a centralized configuration or in a decentralized configuration. The various components of a system that control and regulate a process flow can be arranged in a hierarchical structure.

For example, a servo converter can transmit the corresponding controlled variables directly to a control system. Several controllers located in a station can be connected with each other via a communication bus that enables a direct data exchange.

Intelligent drives can be used for special control tasks, for example in the printing and coil forming industry. An intelligent drive can provide functions that are adapted to the requirements of the application by using control software, for example, by providing a library with different control elements meeting application-specific requirements. These can be conventional components commonly used with control and automation applications, process controllers, industrial controllers, monitoring/diagnostic algorithms, and startup generators.

One example of a prior art drive controller is, for example, the drive controller SIMODRIVE from Siemens Corp., as described, for example, in the manufacturer's service documentation, edition October 2000. These controllers include drive functions, for example a 4-quadrant current control, limitations for synchronous and asynchronous motors with and without rotation speed/position measurement, speed control, operational messages/alarm responses and/or diagnostic functions.

German patent publication no. DE 40 13 960 A1 discloses a method and device for generating a control program. The control program for controlling a machine tool or a robot includes an actuator program, a step program, and a logic program. The actuator program defines an input/output relationship for each actuator based on a basic operating pattern. The step program defines the operating steps of the actuator, whereas the logic program defines logical conditions, such as an interlock condition. This method has the disadvantage that an actuator program has to be generated in a first step based on an operation or an operating pattern of the actuator, before the particular operations of the actuator can be defined that then form the basis for the step program. This method is relatively inflexible and complex and is not suitable for distributed and open systems.

German patent publication no. DE 199 07 604 A1 discloses a graphic user interface for startup, setup, configuring and/or parameterizing converters. Quantities, such as operating data and motor parameters can be entered in the operator console, which then computes from these values parameter sets for parametrizable, electronic control tasks. A graphic user interface displays these quantities and the parameter sets to a user. Disadvantageously, however, the firmware can only be parameterized for a predefined topology, rather than the topology configuration of the firmware itself.

U.S. Pat. No. 5,168,441 discloses a method for graphic programming of application programs in automation technology. This method requires that the automation device includes firmware that allows the generated graphic application program to be loaded into the automation device. Disadvantageously, however, modifications and upgrades of the firmware may be unable to support software development.

It would therefore be desirable and advantageous to provide an improved computer system for configuring firmware for an automation device, which obviates prior art shortcomings and is able to enable upgrades and changes in the firmware.

### SUMMARY OF THE INVENTION

According to one aspect of the invention, a computer system for configuring firmware for an automation device is disclosed, wherein the firmware includes packets. The computer system includes a database with an image of a data model of the firmware of the automation device, an input device for instantiating entities of the data model; and a processor that generates the packets for implementing the instantiated entities. The database stores a first packet for an alarm, a second packet for instantiating a number of axes, and a third packet for a controller. A first attribute for controller-type-independent packets is associated with the first packet, a second attribute for controller-type-independent axial packets is associated with the second packet, and a third attribute for controller-type-dependent axial packets is associated with the third packet.

With the present invention, firmware for an automation device, for example for a drive system, can be efficiently configured, in particular upgraded, scaled and changed. Revisions and modifications of drive systems can advantageously be developed by partitioning the firmware into entities that can be readily interpreted. The software can then be developed, upgraded and maintained in the distributed fashion, for example by the manufacturer and/or by third parties, such as OEM customers. Support can be provided both for the removal and the addition of entities.

Moreover, the firmware is configured based on a data model of the firmware configuration from which possible firmware topologies can be derived. The firmware is configured in a modular fashion, i.e., the firmware is composed of “packets” that are represented in the data model by a corresponding entity.

According to another feature of the present invention, the entities can be linked to attributes and other entities, such as an “alarm block” and/or a “parameter block.” In this way, the relationships between the packets and the properties of the individual packets can be easily recognized. Also supported is the expansion of the firmware through addition of new packets, because the mutual relationship between the existing packets is explicitly shown. If packets are removed, then newly generated firmware always has a configuration that can be executed and compiled.

According to another feature of the present invention, the data model can be mapped to a database, for example Microsoft Access. Accordingly, the database is programmed so as to include an image of the data model of the firmware of the automation device.

An entity of the data model is instantiated when data are entered into the database, thereby defining a desired firmware configuration. As a result, a corresponding firmware topology is obtained, i.e. the packets for implementing the instantiated entities are generated based on the input into the database for instantiating the entities. Preferably, each of the packets includes an interface, enabling the different packets to cooperate for forming executable software.

According to another feature of the present invention, the function of the various packets can be substantiated after the instantiated entities have been implemented, i.e., after the topology of the firmware has been generated. Stated differently, the packets and their interfaces provide “envelopes” for which specific functionalities can still be substantiated.

According to another feature of the present invention, the data model can include a first entity for the packets of the firmware, a second entity for alarm blocks, and a third entity for parameter blocks.

According to another feature of the present invention, the processor can be configured so as to generate an interface for each packet and/or to generate online documentation and/or off-line documentation.

According to another feature of the present invention, the database and image of the data model in the database can be accessed via a graphic user interface, which makes it possible to define and change the entities of the data model and to enter the data required for instantiating the entities into the database.

In accordance with the present invention, firmware changes that are not in conformance with the data model can be effectively prevented, because it is impossible with the present invention to select a non-conforming configuration based on the data model mapped to the database.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a diagram of a computer system according to the invention for configuring firmware; and

FIG. 2 shows a data flow model for the firmware configuration of an automation device.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

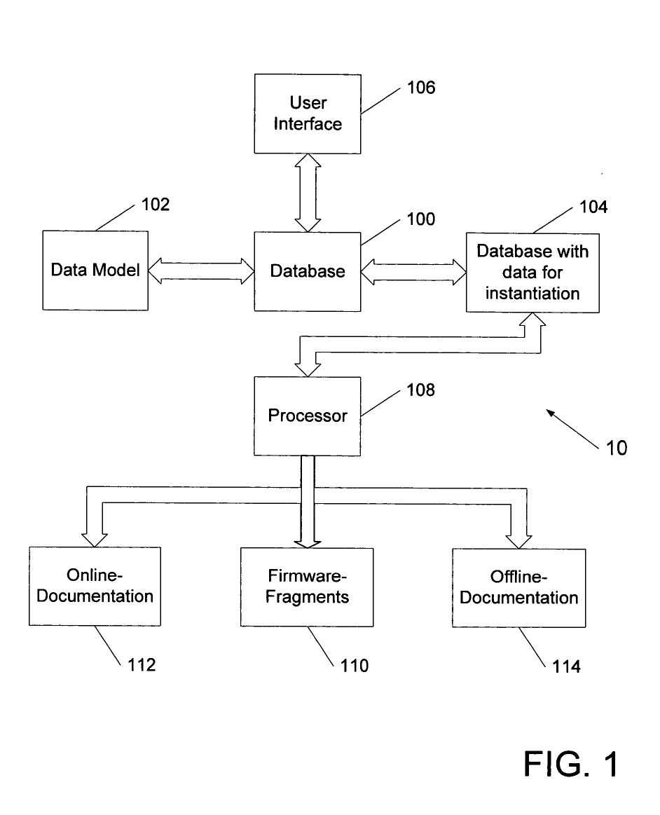

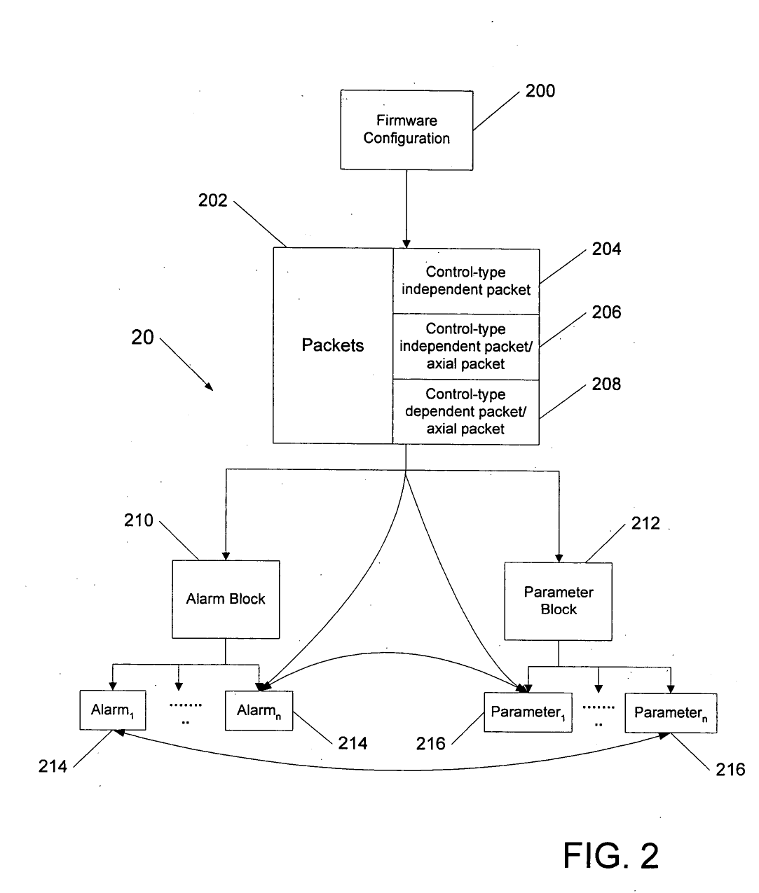

Turning now to the drawing, and in particular to FIG. 1, there is shown a computer system 10 for configuring firmware for an automation device. The computer system includes a database 100 which is used to map a data model 102 of the firmware packets. For example, the data model 102 defines firmware packets for different functions, for example, for current control, speed control, system diagnostics, etc. The firmware packets are stored in a database 104. An exemplary data model 102 will be described in more detail below with reference to FIG. 2.

The database 100 can be accessed via a user interface 106, for example, a graphic user interface that enables graphic selection of the configuration based on the data model 102 stored in the database 100.

The pertinent entities, attributes and mutual relationships are selected via the user interface 106 to define the configuration of the firmware for a particular application. This is also referred to an instantiation of the entities of the data model. The data required for the instantiation are stored in the database 104.

Following the instantiation, a postprocessor 108 accesses the database 104 for generating fragments 110 according to the instantiated entities of the data model firmware. A corresponding firmware fragment 110 is generated for each packet, whereby the generated firmware fragment 110 can include an interface for communication with other firmware fragments 110 (only one firmware fragment 110 is shown). Executable software is generated based on the communication capability among the firmware fragments.

In addition to the firmware fragments 110, the postprocessor 108 can also generate online documentation 112 and off-line documentation 114 by accessing corresponding documentation text blocks associated with the entities, which are then linked to form a documentation.

FIG. 2 shows an exemplary data model 20 of a firmware configuration 200. The firmware configuration 200 includes a plurality of n packets 202; however, the packets 202 can also belong to a several (for example, a total of m) firmware configurations 200.

A packet 202 may not depend on the type of control (attribute 204). Examples for packets that do not depend on the type of control are firmware functions that must be provided for an automation device independent of its control functions, for example alarms.

In addition, an attribute 206 can be associated with a packet 202 to indicate that this packet 202 is an axial packet that is independent of the type of control, i.e., a firmware packet that although related to certain axes, is independent of the type of control. An example of such packet is a firmware packet that is associated with the instantiation of different numbers of axes.

Moreover, an attribute 208 can be associated with a packet 202 that can depend on the type of control, i.e., a firmware packet that is related to controlling a certain axis, for example for controlling a current controller, a speed controller or a position controller or a different type of controller in a cascaded control system.

The data model further includes the entity alarm block 210, whereby a packet 202 can include a plurality of n alarm blocks 210. Conversely, alarm block 210 can also belong to a plurality of different packets 202, for example, m different packets.

The data model further includes a parameter block 212 that is linked to the entity for the packets 202. The entity alarm block 210 is also linked to the entity for the different alarms 214, whereas the entity for the parameter blocks 212 is linked to the entity for the various parameters 216. The entities for the alarms 214 are also linked to the entity for the parameters 216 and to the entity for the packets 202.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A computer system for configuring firmware for an automation device, the firmware comprising packets, said computer system comprising:
a database that includes an image of a data model of the firmware of the automation device, said database storing
a first packet for an alarm, said first packet having associated therewith a first attribute for controller-type-independent packets,
a second packet for instantiating a number of axes, said second packet having associated therewith a second attribute for controller-type-independent axial packets, and
a third packet for a controller, said third packet having associated therewith a third attribute for controller-type-dependent axial packets;
an input device for instantiating entities of the data model; and
a processor that generates the packets for implementing the instantiated entities.

2. The computer system of claim 1, wherein the automation device includes a drive.

3. The computer system of claim 1, wherein the data model comprises a first entity for the packets of the firmware, a second entity for alarm blocks, and a third entity for parameter blocks.

4. The computer system of claim 1, wherein the processor is configured so as to generate an interface for each packet.

5. The computer system of claim 1, wherein the processor is configured so as to generate an online documentation or an off-line documentation, or both.

6. The computer system of claim 1, wherein the input device includes a graphic user interface.

7. The computer system of claim 6, wherein the graphic user interface is configured for entering changes to the data model mapped to the database.
